(19) United States
(12) Patent Application Publication
(10) Pub. No.: US 2007/0271215 A1
(43) Pub. Date: Nov. 22, 2007

(54) System and method for marketing and distribution of multimedia materials

(75) Inventors: Sidney B. Grief, Austin, TX (US); Jeremy J. Coffman, Austin, TX (US)

Correspondence Address: KOPPEL, PATRICK & HEYBL, 555 ST. CHARLES DRIVE, SUITE 107, THOUSAND OAKS, CA, 91360, US

(73) Assignee: AAA News, Inc.

(21) Appl. No.: 11/804,691

(22) Filed: May 17, 2007

Related U.S. Application Data
(60) Provisional application No. 60/801,373, filed on May 17, 2006.

(51) Int. Cl. G06F 17/30

(52) U.S. Cl. 707/1

(57) ABSTRACT

This invention relates to a system and method for the marketing and distribution of goods, and particularly, multimedia materials. One aspect of the present invention provides for a repository for storing product data, a plurality of interfaces for manipulating said product data, and a program for processing said product data. Another aspect provides for storing product data in a centralized repository, manipulating said product data, advertising a product to a customer, and processing customer sales. Another aspect provides for receiving product data from a supplier through an interface, storing said product data in a central repository, generating output using said product data stored in said central repository, and distributing a product.

This application claims the benefit of Provisional Patent Application Ser. No. 60/801,373 to Grief, filed May 17, 2006.

### BACKGROUND OF THE INVENTION

1. Field of the Invention

This invention relates to a system and method for the marketing and distribution of goods, and particularly, multimedia materials.

2. Background

Conventional retail stores typically carry a large variety of items such as magazines, DVDs, books, stickers, incense, posters, and other novelty items. These stores often focus on selling new products, such as magazines, paperbacks and DVDs. When consumers make buying decisions, their primary source of information for new products is often the retail stores' new release section. Retail stores can improve their sales by increasing a customer's awareness of new products before the product arrives at the stores and is placed in the new release sections. However, the vast number of new products and producers of these products makes ascertaining and distributing the information burdensome, time-consuming, and cost-intensive.

To offer products prior to their actual release (pre-sell) date, it is desirable that the store provide an appropriate display for conveying the pre-sell information, as well as order forms for purchasing the new products and design advertising, such as mini-posters for display. The store must create pre-sell forms and establish paperwork flows for receipt of customer's orders and insure that those orders were placed with the distributors in a timely manner. Upon product arrival in the store's warehouse, the store must distribute the products in a timely manner, with each customer's information attached to their individual copy of the product. This process must be coordinated with hundreds of different producers of products. These tasks can be difficult for each retail store to perform, given the amount of information that is scattered across different manufacturers, retailers and distributors.

### SUMMARY OF THE INVENTION

It is an object of the present invention as embodied in the claims to provide a centralized, integrated system and method for marketing and distributing products.

One aspect of the present invention provides for a repository for storing product data, a plurality of interfaces for manipulating and updating said product data, and a program for processing and dynamically updating said product data before a product is released.

Another aspect provides for storing product data in a centralized repository, manipulating said product data, advertising a product to a customer, and processing customer sales before a street date.

Another aspect provides for receiving product data from a supplier through an interface, storing said product data in a central repository, generating output using said product data stored in said central repository, and distributing a product on or after its street date.

### BRIEF DESCRIPTION OF THE DRAWINGS

FIG. 1 is a flowchart illustrating various system users interacting with the computer program and repository through an interface.

FIG. 2 is a flowchart illustrating system users and the various interfaces they utilize to interact with the computer program and repository.

FIGS. 3(a)-(c) are flowcharts illustrating the interaction between system users.

FIG. 4 is a flowchart illustrating receiving product data from a system user through an interface, storing said product data in a central repository, generating output using said product data stored in said central repository, and distributing a product.

FIG. 5 is a flowchart illustrating storing product data in a centralized repository, manipulating said product data, advertising a product to a customer, and processing customer sales.

FIG. 6 is a flowchart that illustrates one example of interaction by a system user with the interface, computer program and repository.

### DETAILED DESCRIPTION OF THE INVENTION

The present invention as embodied in the claims provides a centralized, integrated system and method for marketing and distributing products, particularly multimedia products.

Using as an example the distribution of multimedia products, the present invention is directed to a dynamic system, method and apparatus for the distribution of multi-media data. More specifically, it is directed to a system for pre-selling new products by dynamically creating advertisements for the products, securing a reservation to purchase the product and securing a deposit from the consumer desirous of advance purchase of the product. Embodiments of the invention centralize the data entry, automate distribution of point-of-purchase materials, automate the creation of advertising for print and online, provide a searchable database for customers to find new products, and notify customers on a regular basis of new products as the products become available for pre-sell purchase.

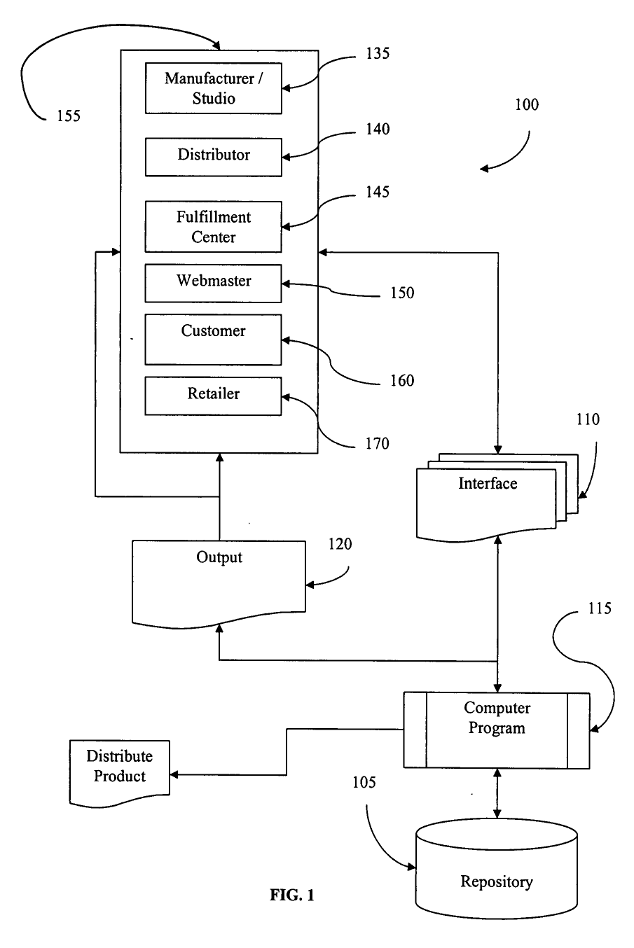

FIG. 1 illustrates one embodiment of a centralized, integrated system for marketing and distributing multimedia products. This embodiment includes a repository 105, an interface 110, and computer program 115 in communication. Although the computer program 115 is shown as a separate element for illustration purposes, it can also include the interfaces and the repository. Thus, the computer program 115, interface 110, and repository 105 can be referred to collectively, or as a combination of two of said components, as the data load and access system 100. System users 155 access the repository 105 through interface 110 and interact with computer program 115 to manipulate multimedia product data in the repository 105. The system users include manufacturer/studio 135, distributor 140, fulfillment center 145, webmaster 150, retailer 170, and customer 160. Generally speaking, these system users can manipulate the repository 105 by adding, updating, deleting, retrieving and searching the product data stored in the repository through interface 110, which either connects to the repository directly or through computer program 115. However, not all system users can perform all of these data manipulations. Customers, for example, typically cannot add, update or delete product data, but can search and purchase products listed in the repository.

The repository 105 typically comprises one or more databases that are centralized and accessible to system users 150 through interface 110. The repository 105 may comprise other data storing mechanisms, devices, systems or structures. Repository 105 stores and provides access to multimedia product data, which includes, but is not limited to, meta-data and appearance data for a particular multimedia product. Meta-data typically includes information about the product itself, while appearance data describes how the meta-data will appear when displayed either electronically or in printed form. For example, a Digital Versatile Disk (DVD) movie product may include meta-data such as the title of the movie, release date, actors, rating, length, etc. and appearance data such as font type and size, background color or pattern, and layout information used to display an advertisement for the movie. Both the meta-data and appearance data preferably appear in the repository 105 before the product is made available to the general public, at a time known as the “street date”. The time period prior to the street date is the “pre-sell” sale period. Providing the meta-data and appearance data before the street date allows customers to search and purchase products (but not necessarily take delivery) before they become generally available. The data may continue to reside in the repository after the street date, thereby allowing customers to search and make purchases even after a product's release to the general public, without requiring any additional input from the manufacturers/studios, retailers, distributors, fulfillment centers, or webmasters.

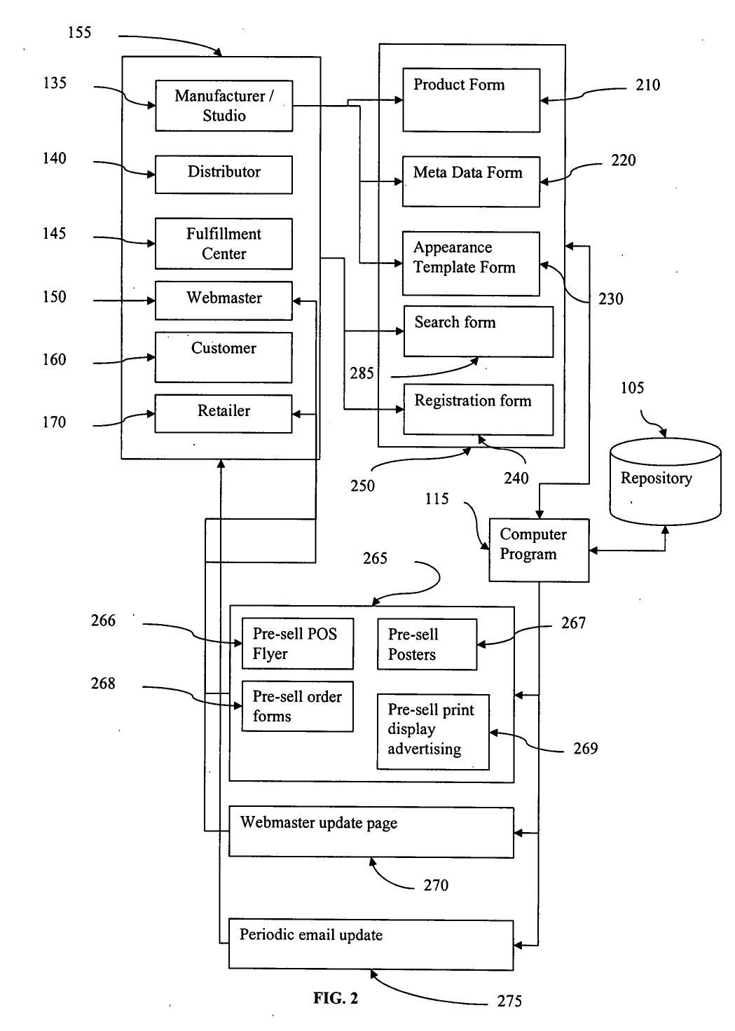

The interface 110 is preferably a set of web pages that are displayed on a system user's computer, and typically comprises hyper text markup language (“html”) tags and/or scripting and/or programming language components that can control the content and/or the appearance of data presented by the interface 110. FIG. 2 illustrates various interfaces that can be used by the system users to manipulate, view and access data in the repository 105. The interface displayed will depend on the intermediary and the function being performed. The interfaces provide, for example, input forms 250 for data entry and outputs 265, 270 and 275 that are provided to system users 155. Input forms can include the registration form 240, product form 210, meta-data form 220, and appearance template form 230. The input forms are typically displayed on the intermediary's display and receive input from the system user. Other input forms are also contemplated.

Output can include the retailer update page 265, webmaster update page 270, and weekly email updates 275. Other outputs are also possible. The retailer update page 265 typically includes the pre-sell Point of Sale (“POS”) flyer 266, pre-sell poster 267, pre-sell order form 268, and pre-sell print display advertising 269. The pre-sell POS flyer 266 is typically a printed document that is dynamically created using product meta-data and appearance data from repository 105 for the retailer to advertise new products to customers using a predefined template that alters the display of the POS flyer 266 based on the appearance data. In one preferred embodiment, one side of the flyer lists the new products by the street date, and the other side of the flyer lists the products by genre. Preferably, the pre-sell flyer is provided in advance of the street date for the product. This makes the customer aware of the product before it is generally available, thereby increasing sales, and helping the customer make an informed buying decision. The pre-sell poster 267 is typically a printed poster that is preferably standardized in size and layout to fit into a picture or display frame, and is dynamically created from the database using the information and appearance data stored in the repository 105. It typically advertises a single product made by a manufacturer/studio. The pre-sell order form 268 is also dynamically created by the computer program 115 using data from repository 105. The form is typically downloaded by the retailer 170, and used to take an order from a customer and provide a receipt, as well as a means for tracking the order. The pre-sell print display advertising 269 includes printed display ads that are dynamically created from the database using templates and appearance data, are periodically updated, such as daily or weekly, and made available to the retailer 170 for downloading and printing. Retailers can place these pre-sell print displays in their local print media to inform customers of products available for pre-sale.

The webmaster update page 270 contains dynamically generated output from the repository 105 in a webpage format such as hypertext markup language (html) or PHP: Hypertext Preprocessor (PHP) that the webmaster 150 can download and include in their website for advertising and processing sales. The output from the webmaster update page 270 takes the form of internet web pages that categorize the new products by manufacturer/studio, street dates (product's date of availability to the public), or any other category of metadata chosen from the repository as a basis for list creation. The information contained in the webmaster update page will preferably be the same as the meta-data entered into the repository by the manufacturers/studios.

The periodic email update 275 typically informs system users 155 of new manufacturing/studios, products for pre-selling, and new retailers. Each system user 155 has its own periodic targeted email update, which can be formatted to contain information different from that of the other system users. For example, manufacturers/studios 135 receive email that includes the names of new manufacturers and studios, new features added to the program, new retailers, and other information that is important to the manufacturers/studio. Retailers 170, distributors 140, fulfillment centers 145, and webmasters 150 each receive an email that includes a listing of new products and new manufacturer/studios. Customers 160 receive an email listing new products with street dates, new manufacturer/studios and new retailers added to the database over the past week. It is contemplated that each system user receives additional information deemed relevant to that system user in the email. Although a weekly email is preferred, the email need only be sent periodically at a different present period, such as daily or monthly. The email is preferably automatically generated, but can be set for manual generation and delivery as well.

Input form 250 allows authorized system users to enter data into the repository. Input form 250 includes, but is not limited to, product form 210, meta-data form 220, appearance template form 230, and registration form 240.

The appearance template form 230 allows each manufacturer/studio 135 to customize the appearance of their marketing materials that are dynamically generated using the templates. For example, the manufacturer/studio 135 can customize the POS poster 266's appearance by specifying a customized background design or color, type styles, font colors and copyright information that will be incorporated with the template for POS poster 266 rendering a unique appearance for each manufacture/studio's advertising. The information entered with this form will be applied globally to marketing materials dynamically generated for each manufacturer/studio.

The meta-data form 220 allows a manufacturer/studio 135 to enter meta-data for the individual product to be pre-sold into the repository 105 or update meta-data previously supplied. The product form 210 allows a manufacturer/studio to add a new product to the repository. For example, the following information could be entered for a movie by a studio via the meta-data form 220: title, front cover picture's URL, back cover picture's URL, suggested retail price, street date, categories for searching (e.g. western), actor's names, director, synopsis, format (e.g. DVD), runtime, URL link to trailer for movie, UPC code, special features (e.g. photo gallery, DTS 5.1, director's commentary, etc.). The information entered using this form is preferably applied specifically to marketing materials dynamically generated for this specific product.

Registration form 240 allows system users to register with the computer program. The appearance and contents of the registration form 240 can differ for each system user in terms of the data requested, and each system user can receive different privileges for searching and modifying the repository. For example, a system user 155 can register with computer program 115 by filling out fields in the registration form 240 for contact names, business name, email addresses, mailing address, username and password for accessing the repository 105. A fulfillment center 145 and distributor 140 can register with the program and provide contact names, business name, email addresses, mailing address, usemame and password for access. Each webmaster 150 can register with the program and provide contact names, business name, email addresses, mailing address, Url, username and password for access. Each retailer 170 can register with the program and provide, contact name, business name, email address, mailing address, username and password for access to the retailer update form 265. Each customer 160 can register with the program and provide their contact information so they can be added to a weekly email update 275 to get new product information. A supplier order form (not shown) can also be dynamically created from the database to cover a range of dates, a particular supplier, both a date range and supplier, or all products in the database and used to send orders from the retailer to his supplier, and provide the retailer with a copy of the order for their records. The supplier order form itself is a dynamic document, so that if a product's name is clicked, the metadata for the product will be displayed in a Product Display window.

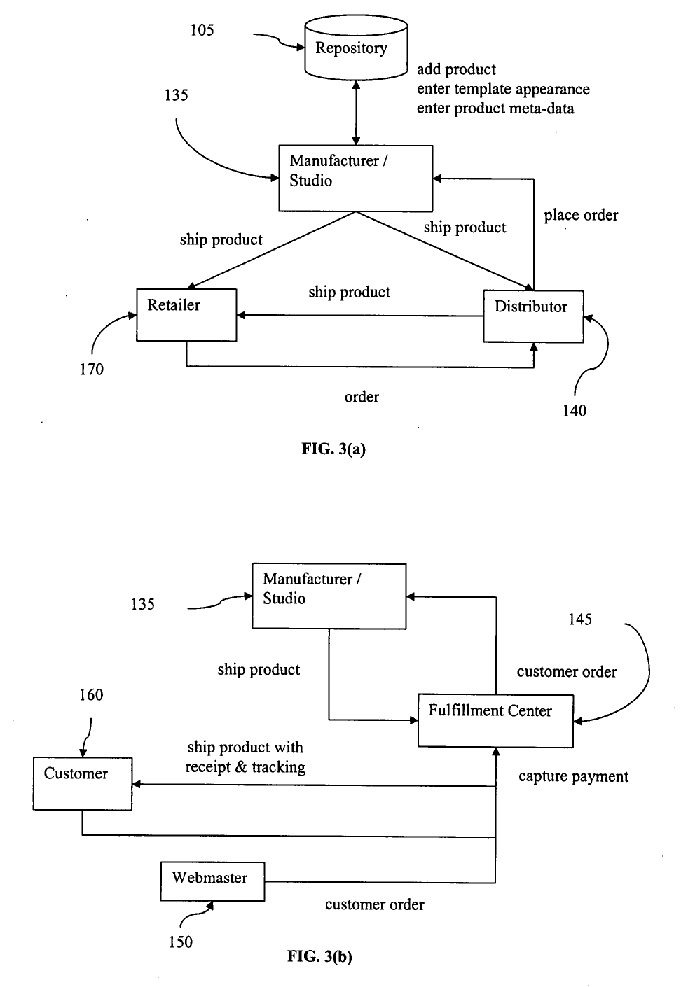

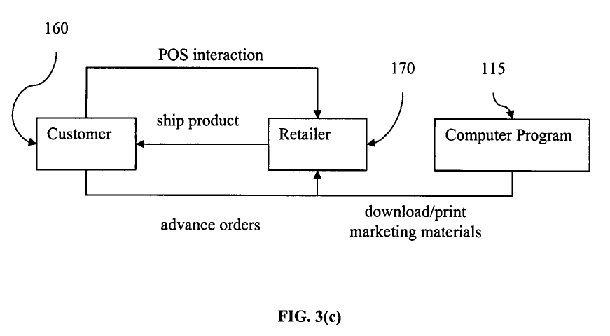

The embodiment depicted in FIGS. 3(a)-(c) shows the preferred interactions between the system users 135, 140, 145, 160, 150 and 170, the computer program the repository 105 through the interface 110.

As illustrated in FIG. 3(a), the manufacturers/studios 135 add the products for pre-sale, enter the template appearance information, enter the product's meta-data into the repository 105, and ship the orders to the distributors 140 and retailers 170 for fulfillment. The distributors 140 take the orders for pre-sold products from the retailers 170 and pass the orders on to the manufacturers/studios 135 and distribute the products from the manufacturers/studios 135 to the retailer 170.

As shown in FIG. 3(b), the fulfillment center 145 takes the orders for pre-sold products from the webmasters 150 through their affiliate programs and pass the orders on to the manufacturers/studios 135. When the product is released, the fulfillment centers 145 capture the payment information from the customers 160 and distribute the products from the manufacturers/studios 135 to the webmaster's customers 160.

As shown in FIG. 3(c), the retailers 170 provide the Point-of-Sale (POS) interaction with the customers 160, print out and make use of the POS marketing materials downloaded from the program, take the advance orders and deliver the products to the customers 160. The webmasters 150 provide the internet online environment for driving traffic to the affiliate programs of the fulfillment center 145 where the advance orders of the customer 160 are captured, monies received, and products shipped on street date. Customers of both “Brick-and-Mortar” retailers and webmasters can make better informed buying decisions, purchase the products in advance of the street date, and make arrangements to received the reserved product on or after the street date.

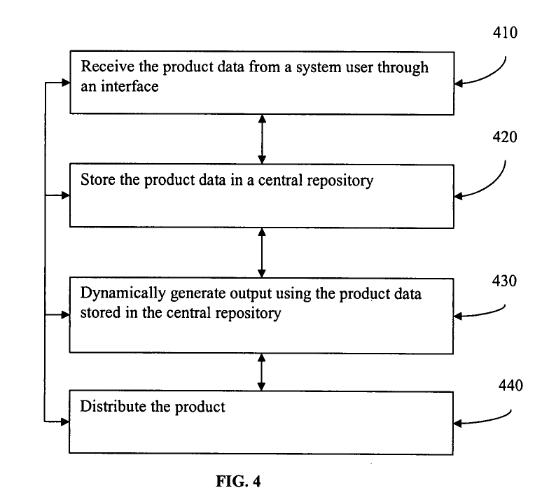

FIG. 4 illustrates a method for marketing and distributing multimedia products comprising receiving product data from a system user through an interface, storing said product data in a central repository, dynamically generating output using said product data stored in said central repository and distributing a product on or after its street date. The elements may be performed in any order as needed, and can include additional elements.

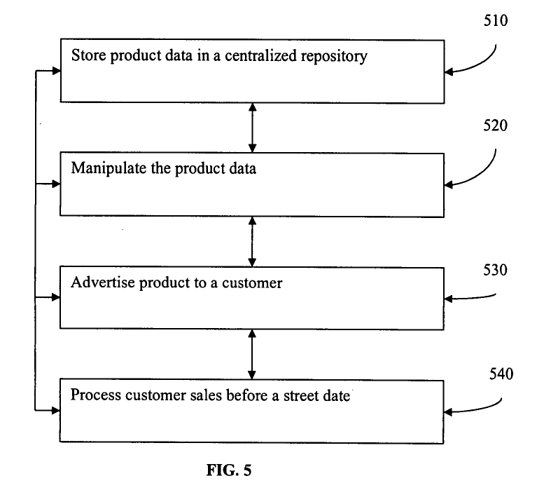

FIG. 5 illustrates a method for marketing and distributing multimedia products comprising storing product data in a centralized repository, manipulating said product data advertising a product to a customer and processing customer sales before a street date. The elements may be performed in any order as needed, and can include additional elements.

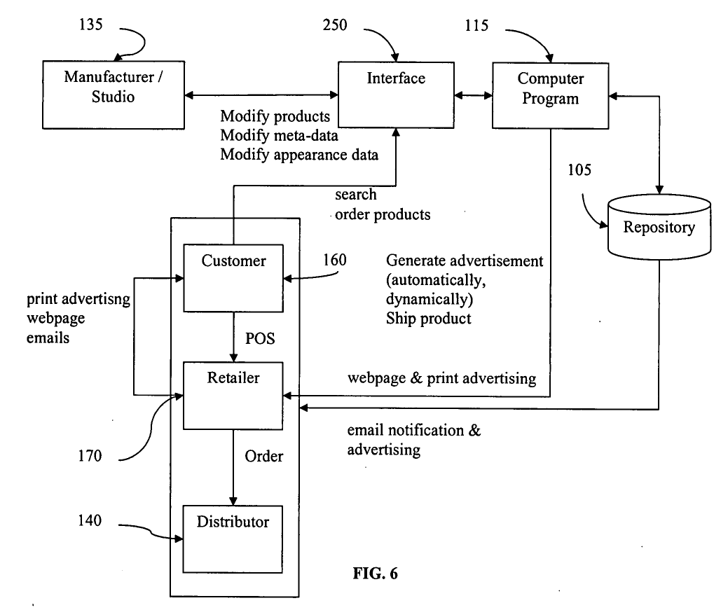

FIG. 6 illustrates an example where a manufacturer/studio 135 first adds a product to the repository 105 through an interface 250 and then enters product meta-data and appearance data through an interface 250 prior to the street date (date before the product is made available to the public) for that product. The manufacturer/studio 135 can also modify data previously entered into the system. The computer program 115 can automatically and dynamically send an email to system users 160, 170, and 140, notifying them of the newly added or modified product. A retailer 170 can then print advertising for upcoming product by accessing an interface that downloads the product's meta-data and formats it based on the appearance data stored in the repository 105. A retailer 170 can also create web page advertisements. A customer 160 who is interested in purchasing the product before it is generally available to the public will either receive an email from the computer program 115, or will see the printed or electronic advertising displayed by retailer 170. Alternatively, the customer 160 can search the repository 105 for meta-data words. The customer 160 can then either place an order for the product before it is generally available to the public with the retailer 170 itself, or can alternatively use an interface 250 to place the order online. Once the customer places the order, the computer program generates a receipt, tracking number and other purchasing and shipping information. When the product becomes available, it is shipped to the customer 160 or retailer 170 along with the customer receipt, tracking number and other purchase information either automatically or manually.

While various implementations and embodiments of have been described, it will be apparent to those of ordinary skill in the art that many more are possible.

What is claimed is:

1. A system for marketing and distributing products before a product is released comprising:
a repository for storing product data;
a plurality of interfaces for manipulating said product data; and
a program for processing and dynamically updating said product data.

2. The system of claim 1, wherein said data comprises meta-data and appearance data for said product.

3. The system of claim 1, wherein said program generates and distributes advertisements for said product using said data.

4. The system of claim 3, wherein said program generates said advertisements automatically and dynamically.

5. The system of claim 3, wherein said advertisements are electronic or printed.

6. The system of claim 1, wherein said program collects customer information through one of said plurality of interfaces, generates a receipt, and transmits to a customer said customer information and said receipt.

7. The system of claim 1, wherein said repository is centralized and accessible to a system user through said plurality of interfaces, wherein said interfaces are electronic.

8. The system of claim 7, wherein said system user comprises one or more of a manufacturer, distributor, fulfillment center, retailer, webmaster or customer.

9. A method for marketing and distributing products comprising:
storing product data in a centralized repository;
manipulating said product data;
advertising a product to a customer; and
processing customer sales before a street date.

10. The method of claim 9, wherein said advertising occurs before a street date and comprises generating and sending electronic advertisement data using said product data.

11. The method of claim 10, wherein said advertising is automatic and dynamic.

12. The method of claim 10, wherein advertising comprises one or more of a pre-sell Point of Sale (POS) flyer, pre-sell poster, or pre-sell print display advertising.

13. The method of claim 9, wherein manipulating said product data comprises manipulating meta-data, appearance template data and product information by a manufacturer or studio.

14. The method of claim 9, wherein processing customer sales comprises taking an order from a first system user before a street date, transmitting said order to a second system user, and distributing a product to said first system user on or after said product's street date.

15. A method for marketing and distributing products comprising:
receiving product data from a system user through an interface;
storing said product data in a central repository;
dynamically generating output using said product data stored in said central repository; and
distributing a product on or after its street date.

16. The method of claim 15, wherein generating output occurs prior to a product street date.

17. The method of claim 15, wherein generating output comprises electronic and print advertising.

18. The method of claim 17, wherein print advertising comprises one or more of a pre-sell Point of Sale (POS) flyer, pre-sell poster, or pre-sell print display advertising.

19. The method of claim 15, wherein said system user comprises one or more of a manufacturer, distributor, fulfillment center, retailer, webmaster or customer.

20. The method of claim 15, wherein said distributing occurs on or after a street date.
